(19) United States
(12) Patent Application Publication
(10) Pub. No.: US 2010/0316862 A1
(43) Pub. Date: Dec. 16, 2010

(54) PARTICLES HAVING A CORE-SHELL STRUCTURE FOR CONDUCTIVE LAYERS

(75) Inventors: Lothar Puppe, Burscheid (DE); Wilfried Loevenich, Bergisch-Gladbach (DE); Andreas Elschner, Muhlheim (DE); Stephan Kirchmeyer, Leverkusen (DE)

Correspondence Address: CONNOLLY BOVE LODGE & HUTZ, LLP, P O BOX 2207, WILMINGTON, DE, 19899, US

(73) Assignee: H.C. Starck Clevios GmbH, Goslar (DE)

(21) Appl. No.: 12/679,809

(22) PCT Filed: Aug. 28, 2008
(86) PCT No.: PCT/EP08/61326

§ 371 Date: Jun. 29, 2010

(30) Foreign Application Priority Data
Sep. 28, 2007 (DE) 102007046904.9

(51) Int. Cl. H01B 1/20; B32B 5/16; C09C 3/10

(52) U.S. Cl. 428/221; 252/500; 428/404; 428/407

(57) ABSTRACT

The present invention relates to particles with core-shell structure comprising an acid-functionalized core based on an inorganic material and a shell comprising at least one conductive polythiophene, to dispersions comprising such particles and to the preparation and use thereof.

The present invention relates to particles with core-shell structure comprising an acid-functionalized core based on an inorganic material and a shell comprising at least one conductive polythiophene, to dispersions comprising such particles and to the preparation and use thereof.

Conductive polymers which are fundamentally water-insoluble or sparingly water-soluble, for example polyaniline, polypyrrole or polythiophene, can be dispersed as a result of the presence of dissolved or dispersed counterions.

In 1992, Armes et al. described the coating of SiO₂ particles with polyaniline (J. Chem. Soc. Chem. Commun., 1992, 108, Langmuir 1992, 8, 2178). Anilines were polymerized in an aqueous medium onto unfunctionalized SiO₂ particles. The product was precipitated by ultracentrifugation, and washed. In some cases, the product was redispersible. To determine conductivities, pressings were produced from the dispersions and precipitates. In the case of mixtures of dispersions and precipitates, conductivities of 2.8 s/cm were found; in the case of true dispersions, conductivities of 0.2 s/cm were found. In 1993 Armes and Maeda described the polymerization of pyrrole onto SiO₂ particles (J. Colloid Interface Sci. 1993, 159, 257, J. Mater. Chem. 1994, 4, 935). Here too, the monomer was polymerized onto unfunctionalized SiO₂ particles. In pressings of the silica-polypyrrole-composite, conductivities of up to 4 S/cm were found.

While the polymerization of polypyrrole and polyaniline onto SiO₂ particles has been described, the polymerization of thiophenes onto inorganic particles has remained unsolved for some time. Owing to its conductivity, stability and transparency in the oxidized state and the resulting numerous possible uses, however, especially poly(3,4-ethylenedioxythiophene) and any application by polymerization were of interest.

In 1999 Kim and Lee described the synthesis of poly(3,4-ethylenedioxythiophene) in the presence of tetraethyl orthosilicate (TEOS) ((Mol. Cryst. and Liq. Cryst. 1999, 337, 213-216). The hydrolysis of TEOS forms SiO₂ particles of uncontrolled size. The gelation process of the SiO₂ and the polymerization process of 3,4-ethylenedioxythiophene (EDT) take place in parallel. The authors describe the preparation of conductive layers with high hardness. The preparation process of Kim and Lee, however, exhibits the disadvantages that the gel formation of the SiO₂ and the polymerization of EDT take place in parallel and control of the morphology of the product as it forms is accordingly in no way possible. A storable dispersion is thus not prepared, which is a disadvantage of the process. A synthesis in a purely aqueous system is not described. A further disadvantage is that the layers produced have to be cleaned with n-butanol and water in order to remove excess oxidizing agent. In the case of a ready-to-use dispersion in which the chemical polymerization is complete, such a cleaning step is unnecessary.

In 2003, Armes and Han succeeded in polymerizing EDT in the presence of a methanolic SiO₂ dispersion (Langmuir, 2003, 19, 4523). EDT is polymerized with ammonium persulphate as an oxidizing agent in the presence of p-toluenesulphonic acid. During the polymerization, a precipitate forms, which was washed by redispersion and centrifugation, and processed to a pressing. On this pressing of the material, a conductivity of 0.2 s/cm was measured.

However, the process described by Armes and Han has the disadvantage that, after the polymerization, a precipitate is initially formed, which has to be redispersed in a second step. Purification and removal of the by-products by repeated centrifugation, washing and redispersion are very costly and inconvenient. A synthesis in a purely aqueous system is not described. A further disadvantage is the fact that not the production of thin films but rather merely of pressings is described.

In 2004, Han and Fougler described the polymerization of EDT in an aqueous silica sol dispersion (Chem. Commun. 2004, 2154). The solubility of EDT is increased by the addition of methanol and/or p-toluenesulphonic acid. There is no exact description of the reaction. More particularly, the polymerization in an aqueous medium in the presence of p-toluenesulphonic acid is not described in detail; it is pointed out merely that p-toluenesulphonic acid protonates EDT and functions as a counterion, and so it cannot be assumed that only catalytic amounts of p-toluenesulphonic acid have been used. There is no description of the conductivity of the particles produced in this publication.

One disadvantage of this reaction is that by-products and unconverted monomers have to be removed by a wash process. Since the SiO₂ surface is not functionalized and free acid is present in the solution, the polymerization of EDT can take place not only at the surface of the SiO₂ but also in the free solution. It can therefore be assumed that the by-products mentioned may also be unbound polythiophene. Moreover, the repeated centrifugation and washing is a costly and inconvenient process step. There is no description of the production of films or pressings from this material.

There was therefore still a need for inorganic particles which are coated with conductive polythiophenes, can be produced in a controlled and simple manner, do not have the above disadvantages and are suitable especially for producing thin conductive layers.

The problem underlying the invention thus consisted in providing such particles and dispersions comprising these particles. It was a further object to discover a simple process for producing them.

It has now been found that, surprisingly, particles whose inorganic core is functionalized with acid groups and whose shell comprises at least one conductive polythiophene achieve this object.

The present invention therefore provides particles with a core-shell structure, the core being based on an inorganic material and the shell comprising at least one conductive polythiophene, characterized in that the core based on an inorganic material comprises covalently bonded acid groups.

What is particularly advantageous about these particles is that a complex bond is formed between the covalently bonded acid groups of the core and the conductive polythiophene(s). This complex bond ensures firstly an exceptional affinity of the polythiophene for the inorganic particles and secondly stronger adhesion of the shell on the core. The increased affinity makes it possible to prevent, in the course of preparation of the polythiophene in the presence of the functionalized inorganic particles, extensive amounts of free polythiophene from forming, which lead later either to inhomogenities of properties in the layers or to material loss, especially of the thiophene.

Useful inorganic materials for the core are especially metal oxides. These are preferably one or more oxide(s) of silicon, of aluminium, of titanium or of zirconium. Particular preference is given to silicon dioxide.

The inventive particles can preferably be produced by first functionalizing dispersed inorganic particles—also referred to hereinafter as inorganic primary particles—with the acid groups and then applying the shell comprising the conductive polythiophene(s).

The inorganic material is accordingly preferably present in dispersed form as a starting material.

Aqueous silicon dioxide dispersions have been known for some time. According to the preparation process, they are present in different forms.

Silicon dioxide dispersions suitable in accordance with the invention may be those based on silica sol, silica gel, fumed silicas, precipitated silicas or mixtures of the above.

SiO₂-containing dispersions suitable for functionalization, for example silica sols, are sedimentation-stable, colloidal solutions of amorphous SiO₂ in water and/or also alcohols and other polar solvents. They usually have the mobility of water, and some of the commercial products have high solids concentrations, preferably of 5 to 60% by weight of SiO₂, and have a great stability with respect to gelation.

Typically, silica sols are milky and turbid through opalescent to colourless and clear, according to the size of the silicon dioxide particles. The particles of the silica sols have diameters of 3 nm to 250 nm, preferably 5 nm to 150 nm. The particles are spherical, three-dimensionally delimited and preferably electrically negatively charged. In the interior of the individual particles, a framework of siloxane bonds is typically present, which arises from the linkage of [SiO₄] tetrahedra or of polysilicic acids. SiOH groups are arranged on the surface. For various applications, preference is given to stable silica sols with specific surface areas of approx. 30 to 1000 m²/g. The specific surface areas can be determined either by the BET method (see S. Brunauer P. H. Emmet and E. Teller, J. Am. Soc., 1938, 60, 309) on dried SiO₂ powder which has been removed from the dispersion by centrifugation or freezing, or directly in solution by titration according to G. W. Sears (see Analytical Chemistry, Vol 28, p. 1981, 1956).

Silica sols are unstable with respect to electrolyte addition, for example sodium chloride, ammonium chloride and potassium fluoride. To balance the charge and for stabilization, silica sols typically comprise monovalent cations, for example alkali metal cations, which originate, for example, from sodium hydroxide solution or potassium hydroxide solution or from soda waterglasses or potash waterglasses, or other alkalis, or else ammonium ions and tetraalkylammonium ions.

Silica sols are prepared by condensing monosilicic acids via a nucleation phase in a so-called growth process, in which small SiO₂ particles grow onto nuclei present. The starting materials are molecular silicate solutions, freshly prepared dilute silica solutions (so-called fresh sol), which comprise particles of <5 nm. Less commonly, silica sol is obtained by peptidizing silica gels or prepared by other processes, for example dispersing amorphous SiO₂ particles. The majority of the processes for preparing silica sols performed on the industrial scale use industrial waterglasses as the starting material.

Suitable waterglasses for the process are soda waterglasses or potash waterglasses, preference being given to soda waterglasses for reasons of cost. Commercial soda waterglass has a composition of Na₂O.3.34SiO₂ and is preferably prepared by melting quartz sand with soda or a mixture of sodium sulphate and carbon to obtain a transparent colourless glass, known as piece glass. In ground faun, this piece glass reacts with water at elevated temperature and pressure to give colloidal, strongly alkaline solutions which are subsequently subjected to a purification.

In addition, a distinction is drawn between fumed silica and precipitated silica. In the precipitation process, water is initially charged and then waterglass and acid, such as H₂SO₄, are added simultaneously. This forms colloidal primary particles which agglomerate with advancing reaction and intermesh to form aggregates. The specific surface area is generally 30 to 800 m²/g and the primary particle size 5 to 100 nm. The primary particles of the silicas present in solid form are generally strongly crosslinked to form secondary aggregates. The specific surface area(s) reported above and specified below are measured to DIN 66131.

Fumed silica can be prepared by flame hydrolysis or with the aid of the light arc process. The dominant synthesis process for fumed silicas is flame hydrolysis, in which tetrachlorosilane is decomposed in a hydrogen/oxygen gas flame. The silica formed is X-ray-amorphous. Fumed silicas have significantly fewer OH groups at their virtually pore-free surface than precipitated silica. Fumed silica prepared by means of flame hydrolysis generally has a specific surface area of 50 to 600 m²/g and a primary particle size of 5 to 50 nm, silica prepared by means of the light arc process has a specific surface area of 25 to 300 m²/g and a primary particle size of 5 to 500 nm.

Further details of the synthesis and properties of silicas in solid form can be found, for example, in K. H. Büchel, H.-H. Moretto, P. Woditsch “Industrielle Anorganische Chemie” [Industrial Inorganic Chemistry], Wiley VCH Verlag 1999, Chapter 5.8.

When an SiO₂ raw material present as an isolated solid is used for the preparation of the inventive particles, for example fumed or precipitated silica, it is converted to an aqueous SiO₂ dispersion, for example, by dispersion.

To prepare the silicon dioxide dispersions, prior art dispensers are used, preferably those which are suitable for generating high shear rates, for example Ultraturrax or dissolver discs.

Preference is given to using those silicon dioxide dispersions whose SiO₂ particles have a primary particle size of 1 to 400 nm, preferably of 3 to 250 nm and more preferably of 5 to 150 nm. In the case that precipitated silicas are used, they are ground for the purpose of particle comminution.

Particular preference is given to using silica sols, very particular preference to using aqueous silica sols, as the silicon dioxide dispersions. Some suitable silica sols are also commercially available.

The acid groups bonded directly to the inorganic core or covalently via alkyl chains are preferably bonded to the surface thereof. In particular, strongly acidic acid groups are useful for this purpose. They are preferably sulphonic acid groups and/or mercapto groups. In the context of the invention, “acid groups” are also understood to mean their salts, especially alkali metal salts, such as sodium and potassium salts, alkaline earth metal salts, such as magnesium and calcium salts, or ammonium salts.

These are preferably those groups of the formula (X) and/or (Y),

—B—(SO₃M)ₚ- (X)

—B—(SH)ₚ— (Y)

in which
B is a (p+1)-valent bridge member,
p is 1 to 3 and
M is hydrogen, an alkali metal cation, especially Li⁺, Na⁺, or K⁺, an alkaline earth metal cation, especially Mg²⁺ or Ca²⁺, or NH₄⁺.

B is more preferably bivalent, i.e. p is 1. B is preferably a linear or branched alkylene group which is optionally interrupted by one or more oxygen atoms and has 1 to 15 carbon atoms, a cycloalkylene group having 5 to 8 carbon atoms or a unit of the formulae

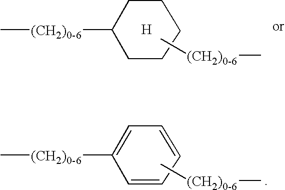

Most preferably, B is —(CH₂)ₙ— where n=1 to 6, especially where n=3.

Preference is given to using silica sols with sulphonic acid groups, especially those of the formula (Z), more preferably those of the formula (Z-I)

—(CH₂)₃—SO₃M (Z-I)

where M is as defined above.

The sulphur content based on SiO₂ of the silica sol is preferably 0.1 to 30 mol %, preferably 0.1 to 8 mol %, especially 1 to 5 mol %. The sulphur content can be determined, for example, by elemental analysis.

Suitable conductive polythiophenes in the context of the invention are preferably those comprising repeat units of the general formula (I),

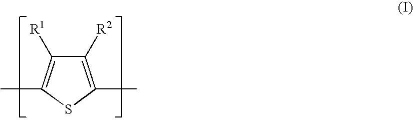

in which
R¹ and R² are each independently H, an optionally substituted C₁-C₁₈-alkyl radical or an optionally substituted C₁-C₁₈-alkoxy radical, or
R¹ and R² together are an optionally substituted C₁-C₈-alkylene radical, an optionally substituted C₁-C₈-alkylene radical in which one or more carbon atom(s) may be replaced by one or more identical or different heteroatoms selected from O or S, preferably a C₁-C₈-dioxyalkylene radical, an optionally substituted C₁-C₈-oxythiaalkylene radical or an optionally substituted C₁-C₈-dithiaalkylene radical, or an optionally substituted C₁-C₈-alkylidene radical in which at least one carbon atom is optionally replaced by a heteroatom selected from O or S.

They are more preferably those polythiophenes comprising repeat units of the general formula (I-a) and/or (I-b)

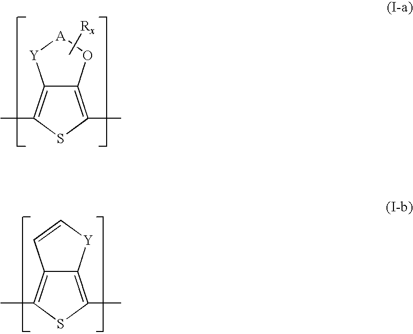

in which
A is an optionally substituted C₁-C₅-alkylene radical, preferably an optionally substituted C₂-C₃-alkylene radical,
Y is O or S,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer from 0 to 8, preferably 0 or 1, and
   in the case that a plurality of R radicals are bonded to A, they may be the same or different.

The general formula (I-a) should be understood such that x substituents R may be bonded to the alkylene radical A.

Polythiophenes comprising repeat units of the general formula (I-a) are preferably those comprising repeat units of the general formula (I-a-1) and/or (I-a-2),

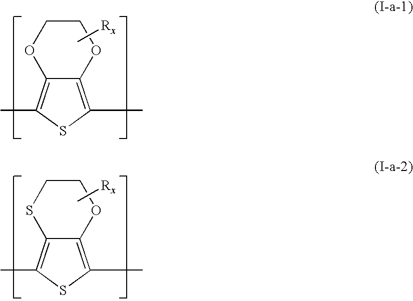

in which
R and x are each as defined above.

They are more preferably those polythiophenes comprising repeat units of the general formula (I-aa-1) and/or (I-aa-2)

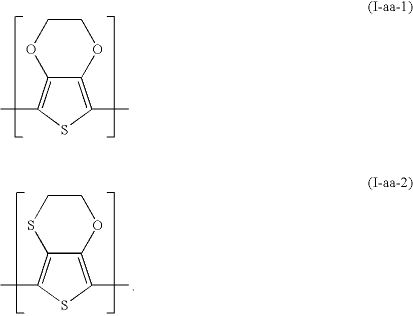

In particularly preferred embodiments, the polythiophene with repeat units of the general formula (I-a) and/or (I-b) is poly(3,4-ethylenedioxythiophene), poly(3,4-ethyleneoxythiathiophene) or poly(thieno[3,4-b]thiophene), i.e. a homopolythiophene formed from repeat units of the formula (I-aa-1), (I-aa-2) or (I-b).

In further particularly preferred embodiments, the polythiophene with repeat units of the general formula (I-a) and/or (I-b) is a copolymer formed from repeat units of the formula (I-aa-1) and (I-aa-2), (I-aa-1) and (I-b), (I-aa-2) and (I-b) or (I-aa-1), (I-aa-2) and (I-b), preference being given to copolymers formed from repeat units of the formula (I-aa-1) and (I-aa-2), and also (I-aa-1) and (I-b), wherein in the formula (I-b) Y represents S.

The polythiophenes may be uncharged or cationic. In preferred embodiments, they are cationic, “cationic” relating only to the charges which reside on the main polythiophene chain. According to the substituent on the R radicals, the polythiophenes may bear positive and negative charges in the structural unit, in which case the positive charges are present on the main polythiophene chain and the negative charges, if appropriate, on the R radicals substituted by sulphonate or carboxylate groups. The positive charges of the main polythiophene chain may be partly or fully balanced by any anionic groups present on the R radicals. Viewed overall, the polythiophenes in these cases may be cationic, uncharged or even anionic. Nevertheless, they are all considered to be cationic polythiophenes in the context of the invention, since the positive charges on the main polythiophene chain are crucial. The positive charges are not shown in the formulae, since their exact number and position cannot be stated unambiguously. The number of positive charges is, however, at least 1 and at most n, where n is the total number of all repeat units (identical or different) within the polythiophene.

Preference is given to using the process according to the invention to prepare conductive polythiophenes with a specific conductivity of more than 10⁻⁸ Scm⁻¹, more preferably of more than 10⁻⁶ Scm⁻¹—most preferably of more than 10⁻⁴ Scm⁻¹ measured on layers of these conductive polythiophenes in the dried state.

To compensate for the positive charge, if this is not already done by any sulphonate- or carboxylate-substituted and hence negatively charged R radicals, the cationic polythiophenes require anions as counterions.

In the context of the present invention, these counterions are preferably provided by the acid groups bonded covalently to the inorganic core.

The present invention likewise further provides dispersions comprising the inventive particles.

The inventive particles preferably have a particle size of 5 nm to 100 μm, more preferably a particle size of 10 nm to 20 μm. The particle size distribution can be determined by means of an ultracentrifuge (Colloid Polymer Sci. 1989, 267, 1113-1116). In case of particles which swell in the dispersion the particle size is determined in the swollen state. The particle size distribution of the particles relates to a mass distribution of the particles in the dispersion subject to the particle size.

In this context, the d₅₀ value of the particle size distribution states that 50% of the total weight of all particles can be assigned to those particles which have a size of less than or equal to the d₅₀ value. A d₉₀ value of the particle size distribution states that 90% of the total weight of all particles can be assigned to those particles which have a size of less than or equal to the d₉₀ value.

The inventive dispersions may have a pH of 1 to 14; preference is given to a pH of 1 to 8.

The solids content of the inventive particles in the inventive dispersion is preferably 0.1-90% by weight, more preferably 0.5-30% by weight and most preferably 0.5-10% by weight.

The inventive particles form a stable dispersion. However, it is also possible to obtain unstable dispersions. These can, for example, be stirred, rolled or agitated before use, in order to ensure a homogeneous distribution of the inventive particles.

The inventive particles are preferably produced directly in dispersion.

The present invention therefore further provides a process for preparing the inventive dispersions, characterized in that dispersions comprising particles based on an inorganic material, i.e. dispersions comprising inorganic primary particles, are functionalized by chemical reaction with acid groups and then, in the presence of these particles comprising covalently bonded acid groups, precursors are polymerized oxidatively to prepare conductive polythiophenes.

For the preparation of the acidic functionalization of the inorganic primary particles, the use of modifiers comprising sulphonic acid groups and/or mercapto groups is particularly suitable. Processes for preparing the modified silica sols and modifiers as described in application DE 10 2004 020 112 A1 are detailed below:

For the optional introduction of the SH groups, the silica sol is

a) reacted with mercapto compounds and, to optionally introduce the sulphonic acid groups,
b) reacted with a compound comprising SO₃M groups or
b1) reacted with a compound comprising a functional group and the functional group itself is converted to an SO₃M group, especially the mercapto compound obtained by a), or
b2) reacted with a compound comprising a functional group, and the silica sol thus derivatized is reacted further with a compound comprising SO₃M groups,
the reaction having been carried out in an aqueous medium with a water content of at least 75% by weight in at least one of stages a), b), b1) or b2), based on the particular reaction mixture.

A preferred compound comprising SO₃M groups is the compound of the formula III

—(CH₃)_{q}Si(OR)ₘ(OH)ₛ—(CH₂)ₜ—SO₃M (III)

in which
m and s are each 0 to 3,
q=0 or 1, and
the sum of q and m and p=3,
t=1 to 15, preferably 1 to 6, especially 3,
M is as defined above and
R is C₁-C₃-alkyl, especially methyl or ethyl.

Particular preference is given to compounds of the formula (III) which correspond to the formula (IIIa)

(CH₃)_{q}Si(OH)ₛ—(CH₂)₃—SO₃M (IIIa)

in which
M, s and q are each as defined above; more particularly, s is 3 and q is 0.

The compound comprising at least one functional group used is preferably a mercapto (SH) compound, which is oxidized after the reaction to an SO₃M compound.

Preferred mercapto compounds are those of the formula (IV)

(CH₃)_{q}Si(OR)ₘ(OH)ₛ—(CH₂)ₜ—SH (IV)

in which
m, s and q are each as defined above,
t is 1 to 15, especially 1 to 6, preferably 3, and
R is as defined above, preferably methyl or ethyl.

A preferred compound of the formula (IV) is that of the formula (IVa)

(CH₃)_{q}Si(OCH₃)ₘ(CH₂)₃—SH (IVa)

in which the sum of q and m=3,
and a compound of the formula (IVb)

(CH₃)_{q}Si(OH)ₛ(CH₂)₃—SH (IVb)

in which the sum of q and s=3 and
in which m, s and q are each as defined above.

The reaction of silica sol with compounds bearing functional groups, especially with mercapto compounds, preferably those of the formulae (IV) and (IVa), is preferably characterized in that the two components are allowed to react at a temperature of 0° C. to 150° C., preferably 0° C. to 100° C. At the same time, possible condensation products such as water and alcohols can be removed from the reaction mixture, preferably continuously, for example by distillation. If appropriate, it is also possible to work in a solvent.

Especially the mercapto groups of the silica sol thus obtained can subsequently be oxidized to sulphonic acid groups in a known manner with an oxidizing agent, preferably H₂O₂.

The oxidation can alternatively also be carried out with ammonium peroxodisulphate, sodium-peroxodisulphate, potassium peroxodisulphate, iron nitrate, tert-butyl hydroperoxide, Oxone (Caro's acid), potassium iodate, potassium periodate, periodic acid.

Mention should also be made of compounds which bear functional groups which serve as anchors and are reactive with compounds which in turn bear one or more SO₃H groups. Such compounds have, for example, the general formula (V)

(CH₃)_{q}Si(OH)ₘ(CH₂)₃—F (V)

where
F is a functional group which can be converted further, for example an SH group, a primary or secondary amino group, and q and m are each as defined above.

Preferred compounds bearing functional groups are:

Si(OCH₃)₃—(CH₂)₃—SH (VI),

CH₃Si(OCH₃)₂(CH₂)₃—SH (VII),

Si(OH)₃—(CH₂)₃—SH (VIII),

CH₃Si(OH)₂(CH₂)₃—SH (IX)

Si(OC₂H₅)₃—(CH₂)₃—SH (X),

CH₃Si(OC₂H₅)₂—(CH₂)₃—SH (XI),

Si(OCH₃)₃—(CH₂)₃—NH₂ (XII),

CH₃Si(OCH₃)₂(CH₂)₃—NH₂ (XIII),

Si(OH)₃—(CH₂)₃—NH₂ (XIV),

CH₃Si(OH)₂(CH₂)₃—NH₂ (XV),

Si(OC₂H₅)₃—(CH₂)₃—NH₂ (XVI),

CH₃Si(OC₂H₅)₂—(CH₂)₃—NH₂ (XVII),

which can in turn be reacted with bifunctional compounds of the general formula

ClO₂S—B₁—(SO₂Cl)ᵤ

in which u=1 or 2
and B₁ is an aromatic bridge member having 6 to 10 carbon atoms.

Particular preference is given to benzenedisulphonyl chlorides, toluenedisulphonyl chlorides or naphthalenedisulphonyl chlorides or naphthalenetrisulphonyl chlorides, which may in turn be substituted again so as to result, for example, in a microparticle system of the general formula

SiO₂—(CH₂)₃—NH—SO₂—C₁₀H₆—SO₃M (XVIII).

It is likewise preferred to react components of the general formulae (VI) to (XVII) with bi- or trifunctional reagents which themselves do not bear a further acid group but are capable of bridge formation. Such compounds are, for example, cyanuric chloride or diisocyanates, especially hexamethylene diisocyanate, p-phenylene diisocyanate or tolylene diisocyanate. They can in turn be reacted again with compounds which are substituted by sulphonic acid groups. Such compounds may be:

Taurine or aromatic sulphonic acids substituted by amino groups which are known from dye chemistry, for example H acid (1-amino-8-hydroxynaphthalene-3,6-disulphonic acid), I acid (2-amino-5-hydroxynaphthalene-7-sulphonic acid) or γacid (2-amino-8-hydroxynaphthalene-6-sulphonic acid).

Preference is given to using compounds III to XVII in an amount of 0.1 to 30 mol %, especially 0.5 to 5 mol %, based on Silicon content of the silica sol.

The invention likewise relates to the products obtainable through reaction of silica sol and a compound of the formula III or IV and, if appropriate, subsequent oxidation.

Silica sols comprising sulphone groups are already known in a different form (for example different particle size or different sulphur content) for catalyst purposes from EP-A-1 142 640, EP-A-63 471, DE-A-2 426 306 and R-D. Badley, T. Ford. J. Org. Chem. 1989, 54, 5437-5443.

In the polymerization of thiophenes, the presence of an acid is required. The functionalization of the inorganic core by means of an acid thus brings about the advantage of a strong linkage of the shell to the core. When this acid is added merely as an additive, as in the case of Armes and Han (Langmuir, 2003, 19, 4523) no direct linkage between the core and the polymer which forms is ensured. In the case of the inventive particles, there is a covalent bond between the inorganic primary particle and the acid group. Between the conductive polythiophene(s) and the acid function, a complex bond of a polycation to a polyanion is formed, such that there is a strong link between polythiophene and silica sol overall.

To prepare the cation/anion complex, the acid-functionalized primary particles are initially charged, preferably directly in dispersion, in preferred embodiments in the form of a silica sol. Suitable dispersants, also referred to hereinafter as solvents, are, for example, aliphatic alcohols, aliphatic ketones, aliphatic carboxylic esters, aliphatic nitriles such as acetonitrile, aliphatic sulphoxides, aliphatic carboxamides, aliphatic and araliphatic ethers, and water. Preferred solvents are water or mixtures comprising water. A particularly preferred solvent is water. Subsequently, precursors for preparation of conductive polythiophenes, one or more oxidizing agents and if appropriate a catalyst are added, and the precursors are polymerized oxidatively to prepare conductive polythiophenes.

The oxidative polymerization from the precursors described is effected, for example, analogously to the conditions specified in EP-A 440 957. An improved variant for the preparation of the dispersions is that of the use of ion exchangers to remove the inorganic salt content or a portion thereof. Such a variant is described, for example, in DE-A 19 627 071. The ion exchanger can be stiffed, for example, with the product, or the product is passed through a column filled with ion exchanger. The use of the ion exchanger allows, for example, low metal contents to be achieved. Finally, a further filtration of the dispersion can be effected.

This simple preparation process is a significant advantage over the prior art. The inventive particles can be prepared directly in dispersion. A concentration or a precipitation with subsequent redispersion are not required.

Suitable precursors for preparing conductive polythiophenes are preferably thiophenes of the general formula (II)

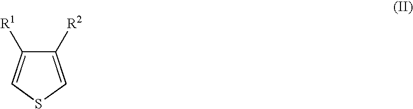

in which R¹ and R² are each as defined for the general formula (I).

Particular preference is given to thiophenes of the general formula (II-a) and/or (II-b)

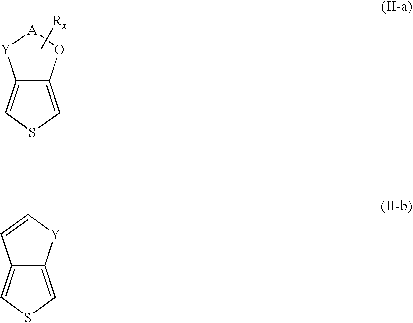

in which A, Y, R and x are each as defined for the general formulae (I-a) and (I-b).

Preferred thiophenes of the general formula (II-a) are those of the general formula (II-a-1) and/or (II-a-2)

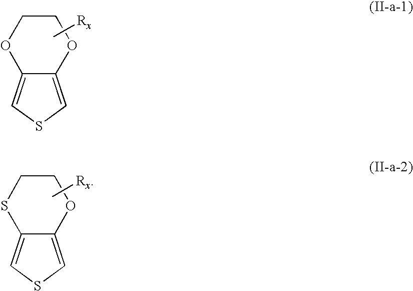

Very particular preference is given to using, as thiophenes of the general formula (II-a), those of the general formula (II-aa-1) and/or (II-aa-2)

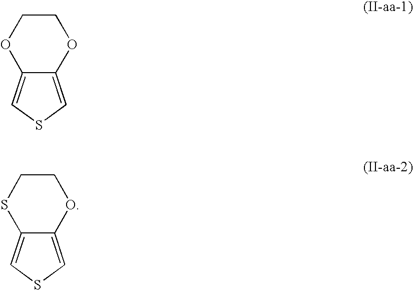

It is also possible in the context of the invention to use derivatives of the thiophenes detailed above as precursors for preparing conductive polythiophenes. In the context of the invention, derivatives of the thiophenes detailed above are understood to mean, for example, dimers or trimers of these thiophenes. Higher molecular weight derivatives, i.e. tetramers, pentamers, etc., of the monomeric precursors are also possible as derivatives. The derivatives may be formed either from identical or different monomer units and may be used in pure form or in a mixture with one another and/or with the aforementioned thiophenes. Oxidized or reduced forms of these thiophenes and thiophene derivatives are also encompassed by the terms “thiophenes” and “thiophene derivatives” in the context of the invention, provided that their polymerization forms the same conductive polymers as that of the thiophenes and thiophene derivatives detailed above.

Processes for preparing the thiophenes and derivatives thereof are known to those skilled in the art and are described, for example, in L. Groenendaal, F. Jonas, D. Freitag, H. Pielartzik & J. R. Reynolds, Adv. Mater. 12 (2000) 481-494 and literature cited therein.

The thiophenes can optionally be used in the form of solutions. Suitable solvents include, in particular, the following organic solvents which are inert under the reaction conditions: aliphatic alcohols such as methanol, ethanol, i-propanol and butanol; aliphatic ketones such as acetone and methyl ethyl ketone; aliphatic carboxylic esters such as ethyl acetate and butyl acetate; aromatic hydrocarbons such as toluene and xylene; aliphatic hydrocarbons such as hexane, heptane and cyclohexane; chlorohydrocarbons such as dichloromethane and dichloroethane; aliphatic nitriles such as acetonitrile, aliphatic sulphoxides and sulphones such as dimethyl sulphoxide and sulpholane; aliphatic carboxamides such as methylacetamide, dimethylacetamide and dimethyl-formamide; aliphatic and araliphatic ethers such as diethyl ether and anisole. In addition, it is also possible to use water or a mixture of water with the aforementioned solvents as the solvent. Preferred solvents are alcohols and water, and also mixtures comprising alcohols or water, or mixtures of alcohols and water.

Thiophenes which are liquid under the oxidation conditions can also be polymerized in the absence of solvents.

The oxidizing agents used may be the oxidizing agents which are known to those skilled in the art and are suitable for the oxidative polymerization of thiophenes; these are described, for example, in J. Am. Chem. Soc., 85, 454 (1963). For practical reasons, preference is given to inexpensive and easy-to-handle oxidizing agents such as iron(III) salts of inorganic acids, for example FeCl₃, Fe(ClO₄)₃, and the iron(III) salts of organic acids and of inorganic acids having organic radicals, and also H₂O₂, K₂Cr₂O₇, alkali metal and ammonium peroxodisulphates, for example sodium or potassium peroxodisulphate, alkali metal perborates, potassium permanganate, copper salts such as copper tetrafluoroborate, or cerium(IV) salts or CeO₂.

For the oxidative polymerization of the thiophenes of the formula II, 2.25 equivalents of oxidizing agent are theoretically required per mole of thiophene (see, for example, J. Polym. Sc. Part A Polymer Chemistry Vol. 26, p. 1287 (1988)). However, it is also possible to use lower or higher equivalents of oxidizing agent.

Examples of iron(III) salts of inorganic acids having organic radicals include the iron(III) salts of the sulphuric monoesters of C₁-C₂₀-alkanols, for example the Fe(III) salt of lauryl sulphate.

Examples of iron(III) salts of organic acids include: the Fe(III) salts of C₁-C₂₀-alkanesulphonic acids, such as those of methane- and of dodecanesulphonic acid, of aliphatic C₁-C₂₀-carboxylic acids, such as that of 2-ethylhexylcarboxylic acid, of aliphatic perfluorocarboxylic acids, such as those of trifluoroacetic acid and of perfluorooctanoic acid, of aliphatic dicarboxylic acids, such as that of oxalic acid, and in particular of aromatic sulphonic acids optionally substituted by C₁-C₂₀-alkyl groups, such as those of benzenesulphonic acid, p-toluenesulphonic acid and of dodecyl-benzenesulphonic acid, and of cycloalkanesulphonic acids such as camphorsulphonic acid.

It is also possible to use mixtures of these aforementioned Fe(III) salts of organic acids.

The aforementioned Fe(III) salts can optionally be used as catalysts in combination with easy-to-handle oxidizing agents such as H₂O₂, K₂Cr₂O₇, alkali metal and ammonium peroxodisulphates, for example sodium or potassium peroxodisulphate, alkali metal perborates, potassium permanganate, copper salts such as copper tetrafluoroborate or cerium(IV) salts or CeO₂.

In the context of the invention, C₁-C₅-alkylene radicals A are: methylene, ethylene, n-propylene, n-butylene or n-pentylene; C₁-C₈-alkylene radicals are additionally n-hexylene, n-heptylene and n-octylene. In the context of the invention, C₁-C₈-alkylidene radicals are C₁-C₈-alkylene radicals listed above comprising at least one double bond. In the context of the invention, C₁-C₈-dioxyalkylene radicals, C₁-C₈-oxythiaalkylene radicals and C₁-C₈-dithiaalkylene radicals are the C₁-C₈-dioxyalkylene radicals, C₁-C₈-oxythiaalkylene radicals and C₁-C₈-dithiaalkylene radicals corresponding to the C₁-C₈-alkylene radicals listed above. In the context of the invention, C₁-C₁₈-alkyl represents linear or branched C₁-C₁₈-alkyl radicals, for example methyl, ethyl, n- or isopropyl, n-, iso-, sec- or test-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl, C₅-C₁₂-cycloalkyl represents C₅-C₁₂-cycloalkyl radicals such as cyclopentyl, cyclo-hexyl, cycloheptyl, cyclooctyl, cyclononyl or cyclodecyl, C₅-C₁₄-aryl represents C₆-C₁₄-aryl radicals such as phenyl or naphthyl, and C₇-C₁₈-aralkyl represents C₇-C₁₈-aralkyl radicals, for example benzyl, o-, m-, p-tolyl, 2,3-, 2,4-, 2,5-, 2,6-, 3,4-, 3,5-xylyl or mesityl. In the context of the invention, C₁-C₁₈-alkoxy radicals represent the alkoxy radicals corresponding to the C₁-C₁₈-alkyl radicals listed above. The above list serves to illustrate the invention by way of example and should not be considered to be exclusive.

Useful optional further substituents of the above radicals include numerous organic groups, for example alkyl, cycloalkyl, aryl, halogen, ether, thioether, disulphide, sulphoxide, sulphone, sulphonate, amino, aldehyde, keto, carboxylic ester, carboxylic acid, carbonate, carboxylate, cyano, alkylsilane and alkoxysilane groups, and also carboxamide groups.

The inventive particles or dispersions are suitable for producing conductive layers.

The present invention accordingly further provides for the use of the inventive particles or dispersions to produce conductive layers.

The conductive layers thus obtainable preferably have a specific conductivity of more than 10⁻⁸ scm⁻¹, more preferably of more than 10⁻⁶ scm⁻¹, most preferably of more than 10⁻⁴ scm⁻¹.

To produce the conductive layers, the inventive dispersions may be applied to a suitable substrate by known processes, for example by spin-coating, impregnation, casting, dropwise application, syringe application, spray application, knife application, spreading or printing, for example ink-jet printing, screenprinting or pad printing.

From the inventive particles or dispersions, it is possible to produce conductive layers which are notable for an exceptional hardness. The hardness of the layers can be determined with the aid of pencil hardnesses to DIN EN 13523. Scratch-resistant layers with conductive, especially antistatic properties are of interest, for example, for the surface treatment of plastics. By virtue of the antistatic properties, they can be used in areas in which antistatic charge is to be prevented, for example everyday items made of plastic, items of clothing, cleanroom equipment and cleanroom consumables.

The present invention therefore further provides the conductive layers, preferably produced using the inventive particles or dispersions.

The examples which follow serve to illustrate the invention by way of example and should not be interpreted as a restriction.

### EXAMPLES

### Example 1

### Preparation of a Dispersion of Acid-Functionalized Silica Sol Particles

1000 g of Levasil® 500/15% were admixed dropwise with stirring with 175 g of a 6% sodium hydroxide solution which contained 0.1 mol % of 1-trihydroxysilylpropane-3-sulphonic acid. After the addition, the mixture was stirred for another 15 minutes (min) and then the resulting dispersion was treated with Lewatit® S 100 in the H form in order to remove the sodium ions. After the ion exchanger treatment, the pH was adjusted to 1.74. The finished silica sol had a solids content of 12.6% by weight of SiO₂.

### Example 2

### Preparation of an Inventive Dispersion Comprising Inventive SiO₂/PEDT Particles

270 g of dispersion from Example 1, 147 g of iron(III) sulphate solution, 1572 g of water and 7.3 g of 3,4-ethylenedioxythiophene (EDT) were mixed and stirred at room temperature for 30 min. Subsequently 12.6 g of sodium peroxodisulphate were added and the mixture was stirred for a further 6 hours (h). There followed a second addition of 7.3 g of EDT and, after 30 min, a second addition of 12.6 g of sodium peroxodisulphate. After stiffing for 14 h, there followed a third addition of 7.3 g of EDT and, after 30 min, a third addition of 12.6 g of sodium peroxodisulphate. After 4 h and a further 3 h and yet a further 4.5 h, another 3.26 g, 2.28 g and 1.8 g, respectively, of sodium peroxodisulphate were added. The resulting reaction mixture was admixed with 400 g of Lewatit® S100H and 800 g of Lewatit® MP 62 (ion exchange resins, Lanxess) and the mixture was stirred for 2.5 h. The ion exchange resins were filtered off using filter paper and the mixture was subsequently filtered through a filter with pore size 0.2 μm.

The resulting product features the following properties:

Solids content: 2.99% by weight based on the total weight of the dispersion
Sodium content: 18 mg/kg
Sulphate content: 240 mg/kg
EDT content 33 mg/kg
d50 particle size 3.03 μm
d90 particle size 8.47 μm

### Example 3

### Determination of the Conductivity of Layers of Core-Shell Complexes

10 g of the inventive dispersion from Example 2 were admixed with 10 g of ethanol, 1 g of dimethyl sulphoxide and 0.1 g of a surfactant. A cleaned glass substrate is placed onto a spin coater and 10 ml of the abovementioned mixture are distributed on the substrate. Subsequently, the supernatant solution is spun off by rotating the plate. Thereafter, the coated substrate is dried on a hotplate at 200° C. for 5 min. The layer thickness is 140 nm (Tencor, Alphastep 500).

The conductivity was determined by using a shadowmask to apply Ag electrodes of length 2.5 cm at a distance of 0.5 mm by vapour deposition. The surface resistance determined with an electrometer was multiplied by the layer thickness in order to obtain the electrical specific resistance. The specific resistance of the layer was 120 ohm·cm. This corresponded to a conductivity of 0.0083 s/cm.

### Example 4

### Determination of the Hardness of Conductive Layers of Core-Shell Complexes

The hardness of the inventive dispersion was compared with reference materials which form part of the prior art. To obtain the films, the sample from Example 2 and the reference materials were admixed with the binder Baypret® 85DU (Lanxess), ethanol, dimethyl sulphoxide (DMSO) and a wax emulsion, Aquacer® 539 (BYK Chemie). With the aid of this mixture, it was possible to obtain stable films. This mixture was then used, by means of a knife (wet film 24 μm), to obtain a film on a glass plate. The film was then dried at 130° C. in a drying cabinet for 15 minutes.

The hardness of the layers was determined with the aid of pencil hardnesses to DIN EN 13523. To this end, pencils of different hardnesses were drawn over a particular film by means of a carriage. The hardest pencil hardness which did not leave any scratches on the film corresponds to the hardness of the film.

The reference material used was firstly a poly(3,4-ethylenedioxythiophene) (PEDT):polystyrenesulphonic acid dispersion (Baytron® P, H.C. Starck GmbH), and a mixture of PEDT:polystyrenesulphonic acid dispersion (Baytron® P, H.C. Starck GmbH) and silica sol (example dispersion 1), and also pure binder.

TABLE 1

| | | | | Aquacer ® | Baypret ® | |
|---|---|---|---|---|---|---|
| | Sample | Ethanol | DMSO | 539 | 85 DU | Hardness |
| Mixture 1 | 10 g of Example 2 sample | 10 g | 1 g | 0.1 g | 2 g | H |
| Mixture 2 | 10 g of Baytron P | 10 g | 1 g | 0.1 g | 2 g | HB |
| Mixture 3 | 10 g of Baytron P + 1.6 g of | 10 g | 1 g | 0.1 g | 2 g | F |
| | Example 1 sample | | | | | |
| Mixture 4 | 10 g of Baypred 85 DU | 0 g | 0 g | 0 g | 0 g | 2H |

Table 1 shows the masses of the particular mixtures used and the hardnesses achieved with them. It becomes clear that a higher hardness is achieved with the inventive sample from Example 2 than using the means available to date according to the prior art. Both Baytron® P and the mixture of Baytron® P and the sample from Example 1 exhibit, in combination with the binder, lower hardnesses (HB and F respectively) than the inventive sample from Example 2 (H). Only the pure binder (Baypret®) exhibits a higher hardness, but this system lacks conductive and antistatic properties.

1.-10. (canceled)

11. A particle with a core-shell structure, the core being based on an inorganic material and the shell comprising at least one conductive polythiophene, wherein the core based on an inorganic material comprises covalently bonded acid groups.

12. The particle according to claim 11, wherein the inorganic material is one or more oxide(s) of silicon, of aluminium, of titanium or of zirconium.

13. The particle according to claim 11, wherein the acid groups are sulphonic acid groups and/or mercapto groups, as well as salts thereof.

14. The particle according to claim 12, wherein the acid groups are sulphonic acid groups and/or mercapto groups, as well as salts thereof.

15. The particle according to claim 11, wherein the conductive polythiophene(s) is/are those comprising repeat units of the general formula (I), 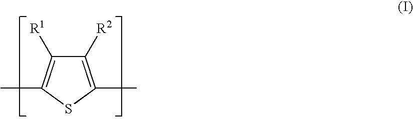
in which
R¹ and R² are each independently H, an optionally substituted C₁-C₁₈-alkyl radical or an optionally substituted C₁-C₁₈-alkoxy radical, or
R¹ and R² together are an optionally substituted C₁-C₈-alkylene radical, an optionally substituted C₁-C₈-alkylene radical in which one or more carbon atom(s) is optionally replaced by one or more identical or different heteroatoms selected from O or S, an optionally substituted C₁-C₈-oxythiaalkylene radical or an optionally substituted C₁-C₈-dithiaalkylene radical, or an optionally substituted C₁-C₈-alkylidene radical in which at least one carbon atom is optionally replaced by a heteroatom selected from O or S.

16. The particle according to claim 14, wherein the conductive polythiophene(s) is/are those comprising repeat units of the general formula (I), 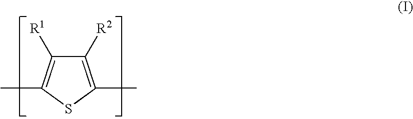
in which
R¹ and R² are each independently H, an optionally substituted C₁-C₁₈-alkyl radical or an optionally substituted C₁-C₁₈-alkoxy radical, or
R¹ and R² together are an optionally substituted C₁-C₈-alkylene radical, a C₁-C₈-dioxyalkylene radical, an optionally substituted C₁-C₈-oxythiaalkylene radical or an optionally substituted C₁-C₈-dithiaalkylene radical, or an optionally substituted C₁-C₈-alkylidene radical in which at least one carbon atom is optionally replaced by a heteroatom selected from O or S.

17. The particle according to claim 11, wherein the conductive polythiophene(s) is/are those comprising repeat units of the general formulae (I-a) and/or (I-b), 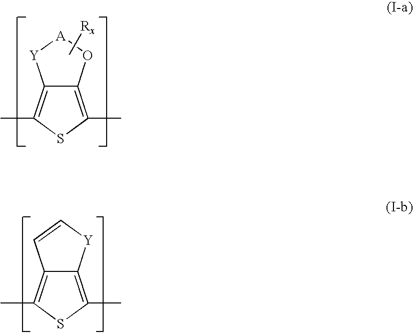
in which
A is an optionally substituted C₁-C₅-alkylene radical,
Y is O or S,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer from 0 to 8 and
in the case that a plurality of R radicals are bonded to A, they may be the same or different.

18. The particle according to claim 14, wherein the conductive polythiophene(s) is/are those comprising repeat units of the general formulae (I-a) and/or (I-b), 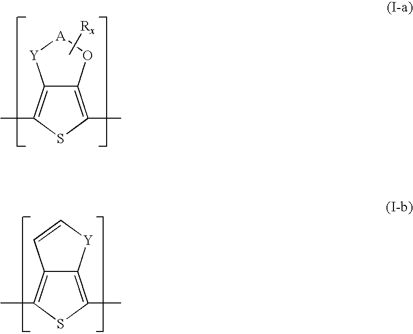
in which
A is an optionally substituted C₂-C₃-alkylene radical,
Y is O or S,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer from 0 or 1, and
in the case that a plurality of R radicals are bonded to A, they may be the same or different.

19. The particle according to claim 11, wherein the particle has a particle size of 5 nm to 100 μm, the particle size being determined by means of ultracentrifugation.

20. The particle according to claim 18, wherein the particle has a particle size of 5 nm to 100 μm, the particle size being determined by means of ultracentrifugation.

21. A dispersion comprising particles according to claim 11.

22. A dispersion comprising particles according to claim 10.

23. A process for preparing the dispersion according to claim 21, which comprises functionalizing particles based on an inorganic material (inorganic primary particles) by chemical reaction with acid groups and then, in the presence of these particles comprising covalently bonded acid groups, precursors are polymerized oxidatively to a prepare conductive polythiophene.

24. A conductive layer which comprises the particle according to claim 11.

25. A conductive layer which comprises the dispersion according to claim 21.

26. A process to produce a conductive layer which comprises utilizing the particle according to claim 11.
